(19) United States
(12) Patent Application Publication
(10) Pub. No.: US 2020/0048054 A1
(43) Pub. Date: Feb. 13, 2020

(54) HEAVE MOTION COMPENSATION SYSTEM

(71) Applicant: ITREC B.V., Schiedam (NL)

(72) Inventors: Joop ROODENBURG, Schiedam (NL); Diederik Bernardus WIJNING, Schiedam (NL)

(73) Assignee: ITREC B.V., Schiedam (NL)

(21) Appl. No.: 16/485,528

(22) PCT Filed: Feb. 13, 2018
(86) PCT No.: PCT/NL2018/050099

§ 371 Date: Aug. 13, 2019

(30) Foreign Application Priority Data
Feb. 14, 2017 (NL) 2018378

(51) Int. Cl. B66D 1/52; E21B 19/00; E21B 19/09

(52) U.S. Cl. CPC B66D 1/525; E21B 19/09; E21B 19/006

(57) ABSTRACT

In a heave motion compensation system and method for adjusting heave motion compensation, for use with an offshore hoisting device, the heave compensation is provided by, firstly, a cylinder having a piston, which is to be connected to a gas buffer for providing the hoisting device with passive HC, and secondly a sheave head, including one or more sheaves for engaging a hoisting wire of the hoisting device, wherein the sheave head is supported by the piston for movement along a HC-trajectory, and thirdly a sheave head track, extending parallel to the HC-trajectory. The adjusting of the passive HC is realized by adjusting movement of the piston of the heave compensation cylinder using an adjusting winch connected to the piston of the cylinder via a trolley supported by a trolley track, which track is located adjacent the HC-trajectory.

The present invention relates to the field of heave motion compensation. In particular, the invention relates to a heave motion compensation system for use with an offshore hoisting device.

Heave motion compensation is used in lifting and drilling activities wherein the heave motion of a vessel—mainly induced by waves—is likely to impair said activities.

For example, when performing a drilling operation from a floating drilling rig, in which the drill string is supported by a hoisting winch, the heave of the rig is compensated for in order to obtain a reduced variation of the weight on drill bit (the downward force on the drill bit).

Heave compensation systems often are employed in vessel-mounted load handling systems, such as wire-suspended load handling systems (e.g. in cranes, derricks, multipurpose towers), see for example WO2007145503 and WO2011034422. In a wire suspended load handling system a load is generally suspended from a wire and commonly a hoisting winch is provided to pay out or take up the hoisting wire.

Heave compensation essentially entails directly adjusting the pay out or take up of the hoisting wire by adjusting the speed of the hoisting winch or indirectly adjusting the pay out or take up by extending and retracting a cylinder supporting a sheave head that engages the hoisting wire.

In heave compensation, furthermore a distinction is made between active systems and passive systems.

Passive heave motion compensation systems differ from the active heave compensation systems in that no external power is consumed. A passive system typically comprises a cylinder linked to the hoisting wire via one or more sheaves. The cylinder is employed as a spring, and thus follows the force exerted by the load on the hoisting wire.

The main benefit of the passive system is that it requires no external energy. Passive heave compensation systems thus have a low power demand and remain operational during black-out, which makes them a low cost and a failsafe.

With active heave compensation, the position of a load relative to the seabed is determined using the real-time signal of a motion or position reference unit. In response to this signal the active heave compensation system will haul in or pay out to keep the load at a constant elevation, for example, by adjusting the speed of the hoisting winch or by extending and retracting the piston of a cylinder linked to the hoisting wire via a sheave head. The main benefit of the active system is that it is more accurate than the passive system.

Often, hoisting devices are provided with both an active heave compensation system and a passive heave compensation system. The active system is used while landing a load onto or picking up from the sea floor or from another vessel. The passive system is used when the load is attached to the seafloor or while it is being lowered towards the sea floor or lifted towards the surface.

It is an object of the invention to provide an improved heave motion compensation system, in particular to provide a passive heave compensation system that is more accurate than prior art heave compensation systems.

The invention provides a heave motion compensation system for use with an offshore hoisting device according to claim 1.

A heave motion compensation system configured for use with an offshore hoisting device comprises:

i. a heave compensation cylinder, having a piston, which heave compensation cylinder is to be connected to a gas buffer for providing the hoisting device with passive heave compensation;
ii. a sheave head, comprising one or more sheaves for engaging a hoisting wire of the hoisting device, wherein the sheave head is supported by the piston for movement along a heave compensation trajectory;
iii. a sheave head track, extending parallel to the heave compensation trajectory;
wherein the heave compensation system is provided with a heave compensation adjusting system, the adjusting system comprising:
i. an adjusting winch with an associated adjusting wire;
ii. a trolley, which trolley is coupled to the piston of the heave compensation cylinder, preferably to the sheave head supported by the piston of the heave compensation cylinder, via a connector device and is coupled to the adjusting winch via the adjusting wire,
iii. a trolley track, which trolley track extends parallel and adjacent to the heave compensation trajectory;
iv. one or more sheaves, located at an end of the adjusting track, for guiding the adjusting wire in a loop along the trolley track, such that the winch can pull the trolley, and thus the piston of the heave compensation cylinder, in opposite directions along the heave compensation trajectory, and
v. a control device, which control device controls the speed of the adjusting winch.

The invention enables adjusting of a passive heave compensation system by adjusting movement of the piston of the heave compensation cylinder using an adjusting winch connected to the piston of the cylinder via a trolley supported by a trolley track, which track is located adjacent the heave compensation trajectory. Thus, the trolley can be located closely adjacent to the piston head, or preferably closely to the sheave head supported by the piston. This configuration allows to provide a compact adjusting system that is able to transfer large pulling forces, required for adjusting a passive heave compensation cylinder, between trolley and heave compensation cylinder.

The invention thus provides a compact and efficient heave compensation system that is more accurate than known passive heave compensation systems and is more energy efficient than known active heave compensations systems.

Employing a trolley, supported adjacent the heave compensation trajectory, for pulling the piston of the cylinder along the heave compensation trajectory allows for a compact system. Thus, the system requires a small footprint and can, for example, be build within the confines of a multipurpose tower.

The use of one or more heave compensation cylinders in combination with a gas buffer for providing passive heave compensation is generally known. An adjusting system according to the invention can be combined with prior art and already installed passive heave compensation cylinders to provide a heave motion compensation system according to the invention. So the invention may be provided as a retrofit on existing heave compensated hoisting devices.

In an embodiment of a heave motion compensation system according to the invention, the piston of the passive heave compensation cylinder has a travelling distance of at least 12 m, preferably at least 14 m, for example has a traveling distance of about 15 m. In embodiments the length of the heave compensation trajectory is substantially the same as the traveling distance of the piston. The trolley track may however extend beyond the length of the stroke of the passive heave compensation cylinder.

In a preferred embodiment, the number of falls per heave compensation cylinder is two, i.e. the sheave head mounted on the piston comprises a single sheave.

A trolley, i.e. a rail bound vehicle, is supported on a track adjacent the heave compensation trajectory of the sheave head. The trolley track moveably supports the trolley, such that the trolley can move along the heave compensation trajectory while movement in a direction perpendicular to the trolley track is prevented. Thus, the main purpose of the trolley track is to keep the trolley adjacent the sheave head, preferably at a constant relative position, while the sheave head and trolley travel along the heave compensation trajectory.

In heave compensation systems, a cylinder is typically connected to the hoisting wire, i.e. to the reeving of a drilling drawworks, using a sheave head. Employing a trolley on a track adjacent the heave compensation trajectory of the sheave head, and thus the outer end of the piston, for pulling the piston of the cylinder along the heave compensation trajectory, allows for integrating the adjusting system with prior art heave compensation systems.

The trolley track comprises one or more rails, preferably two rails, for guiding the trolley, a rail bounded vehicle. Preferably, the trolley and the trolley track are configured such that the can support moment forces caused by the interaction between the heave compensation cylinder and the trolley and/or the interaction between trolley and adjusting winch. This is in particular the case when the wire of the adjusting winch, which pulls the trolley along the trolley track, is located outside a plane defined by the rails of the trolley track and/or when a central axis of the heave compensation cylinder is located outside a plane defined by the rails of the trolley track.

In an embodiment, the trolley is integrated in the passive heave compensation cylinder. For example, the wire of the adjusting winch can be connected to the sheave head directly, which sheave head is embodied as a trolley that is supported in a trolley track. In an alternative embodiment, the trolley is located between the sheave head and the piston, i.e. is an intermediate body that at one end is connected to the sheave head and at an opposite end is connected to the piston of the cylinder. In such an embodiment, the trolley track may also function as the track for guiding the sheave bock. Alternatively, the sheave head is guided by a track comprising two rails and the trolley track is guided by a track comprising two rails, the sheave head track and trolley track each defining a plane, which planes extend perpendicular to each other.

In an embodiment the sheave head track and the trolley track each define a plane, which planes extend perpendicular to each other.

In a preferred embodiment, the sheave head track and the trolley track each define a plane, which planes extend parallel to each other. Preferably, in such an embodiment, the trolley is located adjacent the sheave head, and is connected with the sheave head.

It is furthermore noted that the section of the adjusting wire that extends along the heave compensation trajectory for pulling the trolley along said trajectory, is preferably located within a plane defined by the trolley track. Thus, the adjusting wire pulling the trolley does not introduce a pivoting moment on said trolley.

The heave compensation trajectory is the trajectory along which the sheave head, and thus head of the piston of the cylinder, move during heave compensation. The length of the track is defined by the length of the piston, more in particular by the travel of the piston.

The control device of the adjusting system controls the speed of the adjusting winch, and thus the movement of the heave compensation cylinder. In particular, the control device is configured to adjust the position and/or speed of movement of the cylinder to thus improve the heave compensation provided by the cylinder. The control device can be a computer or similar electronic device, preferably connected to sensors for collecting real time data relevant for determining the adjustment required, e.g. the poison of the piston of the heave compensation cylinder, the heave of the vessel, the tension in the hoisting wire, the position of the load supported by the hoisting device relative to the vessel etc.

Typically, a cylinder in a passive heave motion compensation system acts as a spring and thus follows the forces generated in the hoisting cable by for example heave. This, in combination with friction generated by movement of the sheaves and cylinder, make that the heave compensation provided by the cylinder is not synchronous with the actual heave motion. The adjusting system can be used to compensate, i.e. to improve the heave compensation provided by the cylinder. For example, by providing a pulling force on the cylinder, a delay in movement of the cylinder and/or a lack in amplitude of the cylinder can be reduced or even corrected.

Also, by introducing an adjusting system according to the invention, in addition, or as an alternative, data other than the tension in the hoisting wire can be used in controlling the position if the cylinder, and thus in providing heave compensation. For example, when the hoisting device supports a drilling string, parameters of the drilling process can be used to fine tune the heave compensation provided by the heave compensation cylinder.

The adjusting system moves, more in particular adjusts the speed of movement and/or the position, of the passive cylinder actively with a winch and trolley. The adjusting winch is controlled by the control device, and actively moves the heave compensation cylinder, more in particular the cylinder head with the sheave head, up and down.

With an adjusting passive heave compensation cylinder, or cylinders, the majority of the load, e.g. approx. 90%, is balanced against a volume of gas while only a small portion of the load is balanced by the adjusting winch. Therefore, the power consumption is low compare to an active heave compensation system, e.g. a system using a hoisting winch for providing the heave motion compensation.

In practical embodiments an adjusting winch is small and agile, e.g. more responsive, compared to a hoisting winch. A smaller winch requires less power to run and allows for more accurate compensation due to the smaller inertia of the motor. Another benefit is that there is less wear and tear of the wire (e.g. no drum crushing) compared with an active winch system employing the hoisting winch for providing heave compensation.

In an embodiment, the adjusting heave motion compensation system according to the invention is combined with a hoisting winch of the hoisting device, the hoisting winch being configured for providing active heave compensation. Thus, as an alternative to, or in combination with, the adjusted heave compensation, active heave compensation can be provided by using a suitably embodied hoisting winch. In such an embodiment, preferably the control device of the adjusting system is configured to control both the adjusting winch and the hoisting winch, at least with respect of the heave motion compensation provided with the hoisting winch.

It is submitted that providing the passive heave compensation with an adjusting system allows for improved heave compensation using a heave compensation cylinder, and thus allows for a reduced need of the hoisting winch as an active heave compensation system.

The control device can be a computer or similar electronic device, configured to predict and/or collect heave information, more in particular detect and/or predict the amount of heave compensation and/or adjusting of the heave compensation is required. The control system preferably is connected to sensors for collecting real time data and use this information to automatically control the winch, and thus automatically control the movement of the heave compensation cylinder, more in particular the movement of the piston of the heave compensation cylinder.

The control device of the adjusting system preferably is configured to use real time data, for example on or more of the following:
data on the position of the piston of the heave compensation cylinder relative to a vessel by which the hoisting device is supported; and/or
data on the position of a load supported by the hoisting device relative to the sea floor, and/or relative to another vessel, and/or relative to the vessel on which the hoisting device is supported; and/or
data on drilling parameters, such as variations in the weight on bit and/or pressure variations in the drilling mud and/or variations in the torque and/or the torsion in the drill string; and/or
data on tension in a hoisting wire of the hoisting device and/or in the adjusting wire;
data on the torque delivered by the adjusting winch and/or a hoisting winch of the hoisting device.

Preferably, the connection device engages the cylinder, or the sheave head mounted on the cylinder, at a location in line with the central axis of the cylinder, i.e. in line with the work line of the cylinder, such that pulling and pushing of the cylinder by the trolley does not introduce bending forces in the piston of the cylinder.

Furthermore, the connection between the trolley and the piston of the cylinder, preferably the sheave head mounted on the piston of the cylinder, preferably allows for some movement of the trolley relative to the sheave head or cylinder, at least to such an extent that the connection does not transfer torque in case of a pivoting of the trolley relative to the cylinder and/or the sheave head mounted on the cylinder.

In an embodiment, the connector device is provided in the form of a chain or wire, provided in a double configuration such that the trolley can pull the cylinder in opposite directions along the heave compensation trajectory, or in the form of a hinge, e.g. a ball-and-socket joint.

In a preferred embodiment the connector device is configured as a pin, the pin having a central axis, which central axis crosses the work line, i.e. the central axis, of the heave compensation cylinder; and wherein the connector pin has a connector end that is received in an opening in the heave compensation cylinder, preferably in the sheave head, which opening is located on the work line, i.e. the opening has a central axis the crosses the work line of the cylinder, of the heave compensation cylinder. Thus, pulling and pushing of the cylinder by the trolley does not introduce bending forces in the piston of the cylinder.

In a further embodiment according to the invention, the pin and the opening are shaped such that the connector pin can pivot and/or slide in the opening, such that connection allows for a pivotable movement of the trolley relative to the cylinder head. By allowing the trolley, more in particular the connector device mounted on the trolley, to pivot relative to the opening in which it is received, torque is not transferred by the connection. By allowing the connector device to slide in the opening, the connection can adapt to movement of the trolley relative to the work line of the cylinder, for example due to the trolley track extending at a slight angle relative to the central axis of the cylinder, and thus to the heave compensation trajectory.

In an embodiment, the opening in which the connector pin is mounted has a convex side wall, the apex of which is located at the central axis of the cylinder, such that the pin can pivot while being received in said opening. Such a connection furthermore allows for the pin to slide in the axial direction of the opening. The opening allows thus for pivot movement as well as a translational movement of the trolley relative to the work line for the cylinder.

In a preferred embodiment, the pin is received in an opening provided in the sheave head. The sheave head is typically supported by a guide track, i.e. with rails extending along the heave compensation trajectory, to support the cylinder against sideway movements, for example caused by roll and pitch of a vessel. Due to this support, the sheave head provides a stable platform for receiving the connector device.

In an alternative embodiment, the receiving opening can be part of the top end of the piston of the hydraulic cylinder, or be provided in a component connecting the piston and the sheave head.

In an embodiment, the trolley is connected to a rail of the trolley track at spaced locations, preferably two locations, one on each side of the connector device, such that the track can support a moment acting on the trolley about a moment axis extending perpendicular to the work axis of the cylinder.

In an embodiment, the trolley track comprises two parallel rails, such that the track can support a moment acting on the trolley about a moment axis extending parallel to the work axis of the cylinder.

In a further preferred embodiment, the trolley is supported by two rails, and is connected to said rails at four locations, two spaced locations per rail, which locations correspond with four corners of the trolley, more in particular with four corners of the trolley frame.

In an embodiment, a single rail body provides part of the trolley track and part of the sheave head track. Thus, the rail supports both the sheave head and the trolley, for example the trolley tack and a track for supporting the sheave head are located on opposite sides of said rail, such that the rail is at one side engaged by wheels mounted on the sheave head and on an opposite sides engaged by wheels mounted on the trolley, in an alternative embodiment, the sheave head is supported on the trolley track, the trolley being supported on the same track but being located above or below the sheave head. Thus, a single rail can be used to provide support for both the sheave head and the trolley, which furthermore helps in aligning the sheave head with the trolley, i.e. keeping the sheave head and the trolley at a constant relative position while they move along the heave compensation trajectory.

In an embodiment, the trolley track is located above the cylinder, i.e. alongside the piston of the cylinder when said piston is in the extended position. Due to the piston of the heave compensation cylinder typically having a smaller cross section than the cylinder body, locating the trolley track alongside the piston allows for positioning the trolley, and the adjusting wire puling the trolley, close to the central axis of the heave compensation cylinder, and thus reduces any torque or moment forces generated by the trolley pulling the piston along the heave compensation trajectory.

In an embodiment a single rail body provides part of the trolley track and part of the sheave head track.

In an embodiment, the adjusting winch is mounted at a far end, preferably the top end, of the trolley track, i.e. is located above sheave head when cylinder is in its extended position. Thus, the adjusting winch can be located close to the central axis of the cylinder, which allows for a compact configuration which is especially beneficial when the heave compensation system is mounted with the confines of a drilling mast, multipurpose tower or similar construction.

Preferably the control device is configured to switch the adjusting system between an active mode, in which the adjusting winch pulls the trolley along the heave compensation trajectory to accelerate or decelerate the piston of the heave compensation cylinder, and a passive mode, in which the cylinder can move substantially non-adjusted.

In an embodiment, the switch between adjusted passive heave compensation and regular, or non-adjusted, passive heave compensation is achieved by using the drive to pull the trolley parallel to the piston along the heave compensation trajectory, i.e. without pulling or pushing the cylinder. In another embodiment, the adjusting winch is configured to be pulled by the trolley to allow the cylinder to provide regular passive heave compensation, the winch preferably being disconnected from its drive, in a free run modus. In yet another embodiment, it is envisaged that the trolley can be disconnected from, and reconnected to, the cylinder to switch between an adjusting mode and a non-adjusting mode.

In an embodiment of a heave motion compensation system according to the invention, the adjusting winch is connected with a drive via a clutch, which clutch is configured to provide a free run mode in which the drive and winch are disconnected such that the trolley can be pulled along the heave compensation trajectory by the cylinder. In such an embodiment, the system allows for a condition in which the heave compensation provides passive heave compensation, i.e. the free run mode, and a condition in which the trolley can provide for adjusting the movement of the cylinder, i.e. when the clutch connects the adjusting winch with the drive.

In addition, or as an alternative to the clutch disclosed above, the connector device that connects the trolley with the piston of the cylinder, preferably with the sheave head mounted on the piston of the cylinder, is configured to be coupled and uncoupled, to thus allow for the trolley to be connected or disconnected to the piston or sheave head. The connector device may for example comprise a mechanical or electromechanical coupling on the trolley for engaging a cooperating connector part located on the piston or sheave head.

In such an embodiment the heave compensation system can be switched between a condition in which the heave compensation provides passive heave compensation, i.e. the trolley is not disconnected, and a condition in which the trolley can provide for adjusting the movement of the cylinder, i.e. when the trolley is connected.

In a further preferred embodiment according to the invention the heave compensation system is configured for generating energy by using the passive heave compensator, while providing passive heave, to drive a generator, preferably via the adjusting winch. The energy thus generated by the heave compensation cylinder can be stored, or can be used for other devices on the vessel. In a preferred embodiment the energy is used for driving a hoisting winch, more in particular for providing a hoisting winch with active heave compensation.

In a further preferred embodiment according to the invention the heave compensation system further comprises an energy storage device, e.g. a supercapacitor, for storing energy, e.g. electrical energy, generated by the adjusting winch when the adjusting winch is in the free run condition. The energy thus generated by the heave compensation cylinder can be stored, or can be used on other parts of the vessel.

In an embodiment of a heave motion compensation system according to the invention, the heave compensation system is incorporated in the reefing at a deadline end of the hoist system.

In an embodiment of a heave motion compensation system according to the invention, the heave compensation system comprises two or more heave compensation cylinders, which heave compensation cylinders are to be connected to a gas buffer for providing the hoisting device with passive heave compensation, and wherein at least one of said two or more heave compensation cylinders is provided with a heave compensation adjusting system according to one or more of the preceding claims.

In an embodiment of a heave motion compensation system according to the invention, the heave compensation cylinder provides at least 75% of the heave compensation, e.g. about 80% of the heave compensation, and the adjusting system provides at most 25% of the heave compensation, e.g. respectively about 20% of the heave compensation.

In an embodiment of a heave motion compensation system according to the invention, the control device is configured to control the adjusting winch based on drilling information, e.g. weight on bit information or using data provided by a motion reference unit (MRU), during a drilling process.

In an embodiment of a heave motion compensation system according to the invention, the control device is configured to reduce the effect of the hoisting wire acting as a spring while a load is being lowered towards the sea floor or lifted towards the surface. Thus the speed of the hoisting winch does not, or only to a reduced extent, need to be adapted by the control device to compensate for heave motion.

In an embodiment of a heave motion compensation system according to the invention, the heave compensation system comprises a control device, which control device preferably is the control device that also controls the adjusting winch, which control device is adapted to control the speed of a hoisting winch of the offshore hoisting device to provide active heave compensation by adjusting the speed of the hoisting winch. Thus, the hoisting winch can provide heave compensation in combination with the adjusting passive heave compensation system, allowing the winch to provide only part of the heave compensation, for example 40% of the heave compensation.

In an embodiment of a heave motion compensation system according to the invention, the heave compensation system further comprises an electronic system for detecting and/or predicting heave and/or detecting and/or predicting the position of a load, e.g. a drill string relative to the seafloor, and is configured in using this information in providing heave compensation, i.e. in adjusting the passive heave compensation cylinder and/or providing active heave compensation by controlling the speed of a hoisting winch.

In an embodiment of a heave motion compensation system according to the invention, the heave compensation system further comprises:
i. a second heave compensation cylinder, having a piston, which second cylinder is to be connected to a gas buffer for providing the hoisting device with passive heave compensation;
ii. a second sheave head, comprising one or more sheaves for engaging a hoisting wire of the hoisting device, wherein the second sheave head is supported by the second piston for movement along a second heave compensation trajectory;
iii. a second sheave head track, extending parallel to the second heave compensation trajectory;
   wherein the heave compensation adjusting system further comprises:
i. a second adjusting winch with an associated adjusting wire;
ii. a second trolley, which second trolley is coupled to the piston of the second heave compensation cylinder, preferably to the second sheave head supported by the piston of the second heave compensation cylinder, via a second connector device and is coupled to the second adjusting winch via the adjusting wire associated with the second adjusting winch,
iii. a second trolley track, which second trolley track extends parallel and adjacent to the second heave compensation trajectory;
iv. one or more sheaves, located at an end of the second adjusting track, for guiding the adjusting wire in a loop along the second trolley track, such that the second winch can pull the second trolley, and thus the piston of the second heave compensation cylinder, in opposite directions along the second heave compensation trajectory, and
v. a control device, preferably the control device that controls the speed of the first adjusting winch, which control device controls the speed of the second adjusting winch.

Thus, the passive heave compensation can be provided using the two cylinders in parallel, which allows for a reduced length of the individual cylinders. The invention also allows for more than two passive heave compensation cylinders, for example three passive heave compensation cylinders, of which some or all, for example two out of the three passive heave compensation cylinders, are provided with an adjusting system for adjusting the speed and/or position of the piston of the cylinders while providing heave compensation.

In an embodiment of a heave motion compensation system according to the invention, the control device is adapted to switch the heave compensation cylinder and/or the second heave compensation cylinder between

a heave compensation mode, in which the piston of the respective cylinder is positioned in an intermediate position to provide passive or adjusted passive heave compensation; and
an overload protection mode, in which the piston of the respective cylinder is in a retracted position, and/or
an underload protection mode, in which the piston of the respective cylinder in an extended position.

The invention furthermore provides a floating vessel comprising a hoisting device provided with a heave motion compensation system as described herein. The hoisting device preferably comprises:
a load bearing structure;
a hoisting winch;
a hoisting wire associated with the hoisting winch;
a connecting mechanism for releasable connecting an object to the hoisting wire.

The invention furthermore provides a method for performing offshore drilling activities from a floating vessel, wherein use is made of a hoisting device and a heave compensation system according to the invention. In embodiments a rotary top drive is preferably suspended from the hoisting device while performing drilling with a drill string connected to and driven by said rotary top drive.

In embodiments the heave compensation system, more in particular the one or more passive heave compensation cylinders of the heave compensation system according to the invention, can be mounted in an upright position, for example located inside a drilling mast or in a dedicated vertical housing to be arranged adjacent a drilling derrick. The one or more cylinders may also be mounted in an alternative position, for example in a horizontal position below deck for providing heave compensation for a hoisting device located on deck.

In an embodiment of a heave motion compensation system according to the invention, the load bearing structure is a drilling tower, preferably a drilling mast, or a J-lay pipe laying tower, e.g. wherein the load bearing structure is supporting a rotary top drive for driving a drill string.

In a further embodiment of a floating vessel according to the invention, the load bearing structure is a derrick, and the cylinders and trolley track are provided on the outside of the derrick structure, e.g. in a dedicated vertical housing arranged adjacent the derrick structure.

In an alternative embodiment of a floating vessel according to the invention, the load bearing structure is a tower, e.g. a Multi Purpose Tower, and the cylinders and trolley track are provided on the inside of the tower.

A system as disclosed herein can also be configured to be combined with existing passive heave compensation systems, for example be configured to be mounted on one or more passive heave compensation cylinders already mounted on a derrick or in a crane.

The invention also relates to a method for performing a drilling process from a floating vessel comprising a hoisting device and a heave motion compensation system as described herein, wherein the method comprises:
supporting the drill string from the floating vessel using the hoisting device;
during the drilling process, provide the hoisting device supporting the drill string with passive heave compensation using the heave compensation cylinder;
control the movement of the heave compensation cylinder by using the adjusting winch, and, preferably,
collect drilling information, e.g. “weight on bit”, and use this drilling information to automatically control the adjusting winch, and thus automatically control the movement of the heave compensation cylinder.

The invention provides a method for, on a vessel, providing a hoisting device with heave compensation, the method comprising;
support a load using a hoisting device;
during the hoisting process, provide the hoisting device with passive heave compensation using a heave compensation cylinder, the cylinder preferably having a heave compensation trajectory of at least 7 m;
control the movement of the piston of the heave compensation cylinder by using an adjusting winch, which adjusting winch is connected to the heave compensation cylinder, more in particular to the piston of the heave compensation cylinder and/or to a sheave head mounted on that piston, via a trolley, to pull the piston, and thus compensate for a delay in, and/or lack of, movement of the piston, due to for example friction in sheaves and wires of the hoisting device and/or the cylinder;
preferably, predict and/or collect heave information and use this information to automatically control the winch, and thus automatically control the movement of the heave compensation cylinder, more in particular the movement of the piston of the heave compensation cylinder.

Advantageous embodiments of the heave compensation system according to the invention and the method according to the invention are disclosed in the sub claims and in the description, in which the invention is further illustrated and elucidated on the basis of a number of exemplary embodiments, of which some are shown in the schematic drawing.

In the figures, the last two digits of the reference numbers for elements that correspond in the various figures match with each other.

### BRIEF DESCRIPTION OF THE DRAWINGS

In the drawings:

FIG. 1 shows in cross section a vessel with a hoisting device comprising a first exemplary embodiment of a heave motion compensation system according to the invention;

FIG. 2 shows in close up a section of the vessel of FIG. 1;

FIG. 3 shows a first side view in cross section a drilling mast provided with a second exemplary embodiment of a heave motion compensation system according to the invention;

FIG. 4 shows a second side view in cross section the drilling mast of FIG. 3;

FIG. 5 shows part of the heave motion compensation system of FIG. 3;

FIG. 6 shows a first perspective view of a sheave head and trolley of the heave motion compensation system of FIG. 3;

FIG. 7 shows a second perspective view of the sheave head and trolley of the heave motion compensation system of FIG. 3;

FIG. 8 shows a side view of a sheave head and trolley of the heave motion compensation system of FIG. 3;

FIG. 9 shows a view in cross section of the trolley and sheave head of FIG. 3;

FIG. 10 shows in close up a section of a connector device connecting the trolley and the sheave head of FIG. 3; and

FIG. 11 shows a schematic of a third exemplary embodiment of a heave motion compensation system according to the invention,

FIG. 12 shows a reeving diagram of a hoisting device and a heave motion compensation system according to the invention.

### DETAILED DESCRIPTION OF THE DRAWINGS

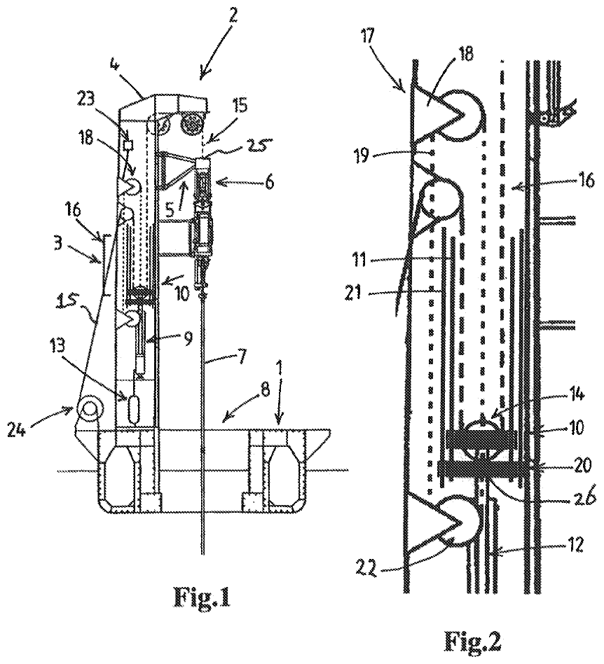

FIG. 1 shows in cross section a vessel 1 with a hoisting device 2 comprising a first exemplary embodiment of a heave motion compensation system 3 according to the invention. FIG. 2 shows in close up a section of the vessel of FIG. 1.

The heave motion compensation system 3 depicted is an adjusting heave motion compensation system for use with an offshore hoisting device. The exemplary embodiment shown is mounted on a floating vessel 1, here inside a load bearing structure in the form of a drilling mast 4.

The heave compensation system 3 is combined with a hoisting device 2 comprising a hoisting winch 24, a hoisting wire 15 associated with the hoisting winch 24, and a connector device 25 for releasable connecting an object to the hoisting wire 15. In the embodiment shown, the connector device 25 is providing on a hoisting trolley 5 that is supported for vertical movement along a guide track along the outside of the drilling mast 4. Furthermore, in the embodiment shown, the hoisting device 2 supports a top drive 6 and a drilling string 7. The drilling string 7 passes into the sea via a moonpool 8 through the hull of the vessel 1.

The heave compensation system 3 is associated with the hoisting wire 15 for damping the effect of the movement of the floating vessel 1, as a result of heave and beating of waves, onto an object supported by the hoisting wire 15, in the embodiment shown the drilling string 7.

The heave compensation system 3 comprises a heave compensation cylinder 9, a sheave head 10, and a sheave head track 11. This configuration as such is known from the prior art.

The heave compensation cylinder 9 has a piston 12. As known from the prior art, the cylinder 9 is connected to a gas buffer 13, e.g. a nitrogen buffer, for providing the hoisting device 24 with passive heave compensation. Passive heave compensation systems are typically connected to a gas buffer using a medium separator. It is submitted that these type of heave compensation systems, and there lay-out are generally known from the prior art, and will not be discussed in detail herein.

The sheave head 10 comprises a sheave 14 engaging the hoisting wire 15 of the hoisting device 2. The sheave head 10 is supported by the piston 12 for movement along a heave compensation trajectory 16, e.g. vertically up and down.

Here the heave compensation trajectory 16 extends in the upper part of the drilling mast 4.

The heave compensation trajectory is the trajectory along which the sheave head 10, and thus head of the piston 12 of the cylinder 9, moves during heave compensation. The length of the track is generally defined by the length of the piston 12, more in particular by the travel of the piston.

The sheave head track 11 as shown comprises two rails, here vertical, shown here as a pair of continuous lines, extending parallel to the heave compensation trajectory. With known passive heave compensation systems typically a sheave head track is provided to support the sheave head while it moves along the sheave head trajectory. The support by the sheave head track in particular prevents the sheave head, and thus the piston of the heave compensation cylinder, from moving, respectively bending, sideways, i.e. in a direction perpendicular to a longitudinal axis of the cylinder.

According to the invention, the heave compensation system 3 is an adjusting heave compensation system, i.e. is provided with a heave compensation adjusting system 17. In the exemplary embodiment shown, the adjusting heave compensation system is mounted in the drilling mast 4, with the adjusting system 17 being mounted adjacent the heave compensation cylinder 9 of the heave compensation system.

The adjusting system 17 comprises an adjusting winch 18, with an associated adjusting wire 19, a trolley 20 supported by a trolley track 21 that extends parallel and adjacent to the heave compensation trajectory 16, a sheave 22, and a control device 23, which control device 23 controls the speed of the adjusting winch 18.

The trolley 20 is coupled to the piston 12 of the heave compensation cylinder 9, in the embodiment shown is connected to the top end of the piston, i.e. forms a connecting part between piston 12 and sheave head 10, via a connector device 26 and is coupled to the adjusting winch 18 via the adjusting wire 19.

In the particular embodiment shown, the connector device 26 is embodied as a pin-in-hole hinge connection on opposite sides of the trolley, in other words, the trolley is located between the top end of the piston and the bottom side of the sheave head. At the top side of the trolley, a connection between trolley and sheave head is provided and at the bottom side of the trolley a connection between trolley and piston is provided. In the particular embodiment shown, the connector device is thus embodied as two hinged connections, such that it allows for some relative movement of the components, i.e. plunger, trolley and shave head.

The invention allows for many types of connector devices 26, for example for bolted connections, or for fixed connections, e.g. in the form of welds. However in a preferred embodiment, the connector device allows for some relative movement of the trolley 20 with respect to the piston 9 and/or sheave head 10 of the heave compensation system, in such a way that only a pulling force in line with a central axis of the heave compensation cylinder is transferred between trolley 20 and sheave head and/or cylinder, and no forces perpendicular to the central axis of the heave compensation cylinder, which would bend the piston, are transferred between trolley and piston and/or the sheave head supported by the trolley.

According to the invention, the adjusting system 17 comprises an adjusting winch 18 with an associated adjusting wire 19, and one or more sheaves 22 that guide the adjusting wire along the trolley track such that the adjusting winch, via the adjusting wire, can pull the adjusting trolley 20 in opposite directions along the trolley track 21.

In the depicted example the adjusting winch 18 is located at an end, here the top end, of the trolley track 21. The winch 18 supports both ends of the adjusting wire, such that the wire is looped, e.g. the ends reeved in opposite directions on a common drum. Thus, when the winch drum 18 rotates clockwise, the looped wire 19 is pulled in a clockwise direction and the trolley 20 is moved in a downward direction along the trolley track, and when the winch drum 18 rotates counter clockwise, the looped wire 19 is pulled in a counter clockwise direction and the trolley 20 is moved upwards along the trolley track.

In the embodiment shown, the adjusting system comprises one sheave 22. The sheave 22 is here located at a bottom end of the trolley track 21 for guiding the adjusting wire 19 in a loop along the trolley track, such that the adjusting winch 18 can pull the trolley 20 connected to the wire in opposite directions along the heave compensation trajectory, as was already set out above. Thus, the winch 18 can pull the piston of the heave compensation cylinder, which is connected to the trolley, along the heave compensation trajectory as well.

It is submitted that in the embodiment shown, the adjusting wire 19 is looped in a simple way, i.e. from the winch 18 over a single sheave 22 and back to the winch 18. It is submitted that the invention allows for more elaborate configurations, i.e. multiple sheaves guiding the adjusting wire, sheaves configured for providing tension in the adjusting wire, etc. for example, in an embodiment, the winch is located halfway the trolley track and a sheave is provided at each end of the trolley track for guiding the looped wire along the trolley track, of which sheaves at least one is hingeable supported and biased, to keep the looped wire at a predetermined minimum tension.

In the embodiment shown, both the trolley track and the sheave head track comprise two rails, shown as a pairs of continuous lines 11, 21, for supporting the sheave head and the trolley respectively. In an alternative embodiment according to the invention, the sheave head and the trolley are supported on the same track, or the sheave head track and the trolley track are partially integrated. In the latter embodiment, the for example a double sided rail is provided, which at one side forms a guide for the trolley and on the other side for the sheave head.

The exemplary embodiment of an adjusting heave compensation system 3 according to the invention shown in FIGS. 1 and 2 enables providing the hoisting device 2 with adjusted heave compensation according to the invention.

The adjusting system according to the invention enables adjustment of a passive heave compensation system by adjusting movement of the piston 12 of the heave compensation cylinder 9 using the adjusting winch 18 connected to the piston 12 via the trolley 20 supported by the trolley track 21.

The trolley track 21 is located adjacent the heave compensation trajectory 16, such that the trolley can be located closely adjacent to the piston head, i.e. the top end of the piston 12 and closely to the sheave head 10 supported by that piston. This configuration provides a compact adjusting system that is able to transfer the large pulling forces, required for adjusting a passive heave compensation cylinder, between trolley and heave compensation cylinder without the introduction of large moment forces, i.e. forces in a direction perpendicular to the central axis of the cylinder.

The load, in the embodiment shown formed by the drilling string 7, is supported using the hoisting device 2. During the hoisting process, the hoisting device 2 can be provided with passive heave compensation using the heave compensation cylinder 9. Furthermore, according to the invention, the movement of the piston 12 of the heave compensation cylinder 9 can be controlled by using the adjusting winch 18. In the embodiment shown, the adjusting winch 18 is connected to the heave compensation cylinder 9, more in particular to the piston 12 of the heave compensation cylinder 9 and to the sheave head 10 mounted on that piston 12, via the adjusting trolley 20, to pull the piston 12, and thus compensate for a delay in, and/or lack of, movement of the piston, due to for example friction in sheaves and wires of the hoisting device and/or the cylinder.

It is submitted that the adjusted heave compensation is generated by the adjusting winch 18 pulling the trolley 20 along the trolley track 21, which adjusting winch 18 is controlled by the control device 23. The control device 23 is configured to predict and/or collect heave information and use this information to automatically control the adjusting winch 18, and thus automatically control the movement of the piston of the heave compensation cylinder, more in particular, adjust the movement of the piston.

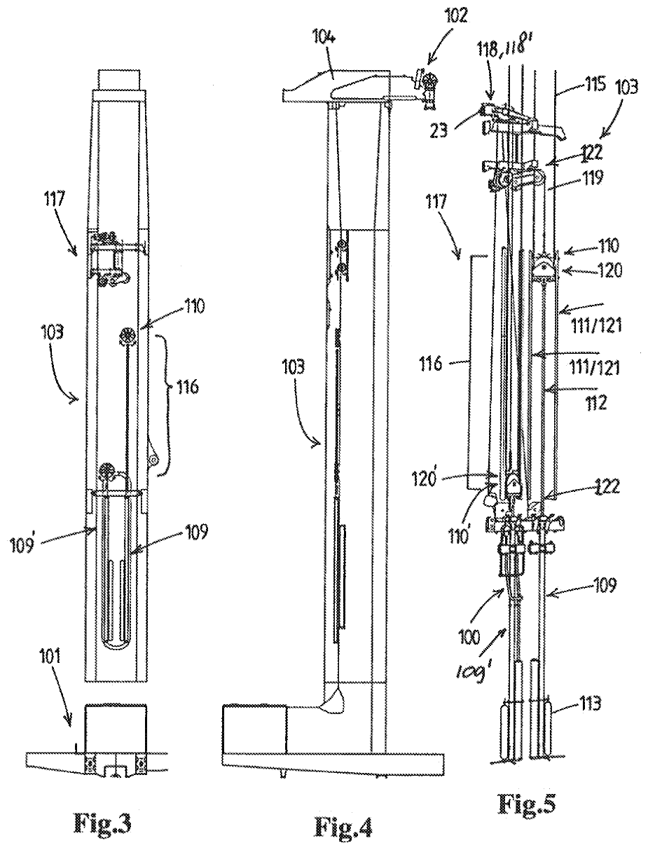

A second exemplary embodiment of an adjusting heave compensation system 103 according to the invention is shown in FIGS. 3-9.

The heave motion compensation system 103 depicted is an adjusting heave motion compensation system for use with an offshore hoisting device. The exemplary embodiment shown is mounted on a floating vessel 101, here inside a load bearing structure, here embodied as a crane 104. The crane is combined with a hoisting device, comprising a hoisting winch, a hoisting wire associated with the hoisting winch, and a connector device for releasable connecting an object to the hoisting wire.

For the sake of clarity, the hoisting device is not completely depicted in the figures, only the hoisting wire 115 is shown. However, it is similar in configuration and lay-out to the hoisting device shown in FIG. 1. It is submitted that these types of hosting devices as such are generally known in the prior art.

The hoisting device is combined with a heave compensation system 103, which heave compensation system is associated with the hoisting wire 115 of the hoisting device for damping the effect of the movement of the vessel, as a result of heave and beating of waves, onto an object supported by the hoisting wire 115.

The heave compensation system 103 is similar in lay out and configuration to the heave compensation system 3 shown in FIGS. 1-2, but in addition to a first heave compensation cylinder 109 provided with a first adjusting system 117, the heave compensation system comprises a second heave compensation cylinder 109′ provided with a second adjusting system 117′, the first and second adjusting system sharing a single common control device 23.

In FIGS. 3-5 one of the cylinders 109′ is shown in the retracted position, and one (109) of the cylinders is shown in the extended position.

The heave compensation system 103, comprising both the heave compensation cylinders, is combined with the hoisting device. The sheaves of the heave compensation winches engage the hoisting wire 115 associated with the hoisting winch of the hoisting device.

Thus, the adjusting heave motion compensation system 103 can provide passive heave compensation using the two cylinders 109, 109′ in parallel, or using only one of them.

In the particular embodiment shown the heave compensation system 103 allows furthermore for using one cylinder for providing passive heave compensation, i.e. with the adjusting winch in a free run mode such that the heave compensation cylinder pulls the trolley along the heave compensation trajectory, while the other cylinder provides adjusted heave compensation, i.e. with the winch pulling the trolley, and thus the piston of the cylinder, along the heave compensation trajectory. Also, both cylinders 109, 109′ can be used for providing adjusted heave compensation in parallel.

It is submitted preferably the control device 23 is configured to switch the adjusting system between an active mode, in which the adjusting winches pull the trolleys along the heave compensation trajectory to accelerate or decelerate the piston of the heave compensation cylinder, and a passive mode, in which the cylinders can move non-adjusted.

In an embodiment, the switch between adjusted passive heave compensation and regular, or non-adjusted, passive heave compensation is achieved by using the drive to pull the trolley parallel to the piston along the heave compensation trajectory, i.e. without pulling or pushing the cylinder. In another embodiment, the adjusting winch is configured to be pulled by the trolley to allow the cylinder to provide regular passive heave compensation, the winch preferably being disconnected from its drive, in a free run modus. In yet another embodiment, it is envisaged that the trolley can be disconnected from, and reconnected to, the cylinder or sheave head to switch the adjusting heave compensation system between the adjusting mode and the non-adjusting mode.

FIG. 5 shows part of the heave motion compensation system of FIG. 3, i.e. the first heave compensation cylinder 109 with first sheave head 110, first trolley 120, and first trolley track 121 and the second heave compensation cylinder 109′ with second sheave head 110′, second trolley 120′, and second trolley track 121′.

In the preferred embodiment shown, each trolley track is located above the cylinder, i.e. alongside the piston of the cylinder when said piston is in the extended position. Due to the piston of the heave compensation cylinder typically having a smaller cross section than the cylinder body, locating the trolley track alongside the piston allows for positioning the trolley, and the adjusting wire puling the trolley, close to the central axis of the heave compensation cylinder, and thus reduces any torque or moment forces generated by the trolley pulling the piston along the heave compensation trajectory.

It is noted that, in contrast with the heave compensation system shown in FIG. 1, the, the adjusting wires 119, 119″ are guided over multiple sheaves 122, 122′ which sheaves are located at both ends of the trolley tracks 121, 121′.

Furthermore, the first adjusting winch 118 and the second adjusting winch 118′ are each provided at the far end, i.e. the top end, of the respective trolley tracks 121, 121′. Thus, each adjusting winch is located above sheave head when cylinder is in its extended position. Therefore, the adjusting winch can be located close to the central axis of the cylinder, which allows for a compact configuration which is especially beneficial when the heave compensation system is mounted with the confines of a drilling mast, multipurpose tower or similar construction.

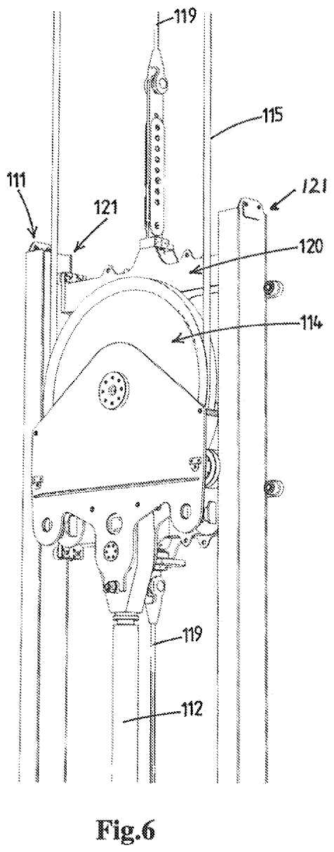

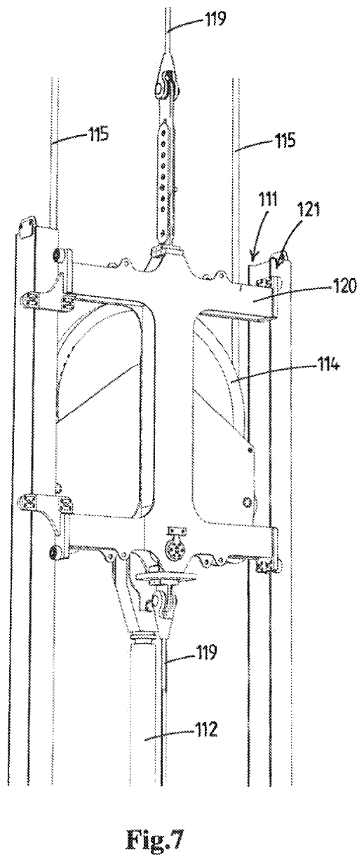

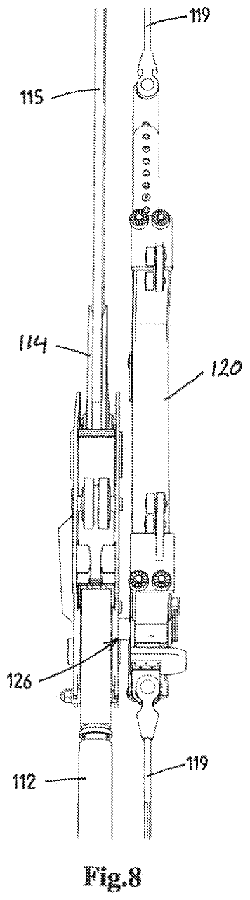

FIG. 6 and FIG. 7 show perspective views of the sheave head 110 and trolley 120 of the heave motion compensation system 103 of FIG. 3, while FIG. 8 shows a frontal perspective view of a sheave head and trolley of the heave motion compensation system of FIG. 3.

The trolley 120 is a rail bound vehicle, and is in the embodiment shown supported on a trolley track 121 adjacent the heave compensation trajectory 116 of the sheave head 110.

The trolley track 121 moveably supports the trolley 120, such that the trolley can move along the heave compensation trajectory while movement in a direction perpendicular to the trolley track is prevented. The main purpose of the trolley track 121 is to keep the trolley 120 adjacent the sheave head 110, at a constant relative position, while the sheave head 110 and trolley 120 travel along the heave compensation trajectory.

In the embodiment shown, the trolley track 121 comprises two rails guiding the trolley 120. The trolley and the trolley track are configured such that they can support moment forces caused by the interaction between the heave compensation cylinder and the trolley and/or the interaction between trolley and adjusting winch.

The sheave track 111 comprises two rails guiding the sheave head 110. Both the sheave head 110 and the trolley 120 are provided here with wheels that engage the rails.

In the preferred embodiment according to the invention, the trolley track and the sheave head track each comprise rails that are pairwise part of a common profile element. In the particular embodiment shown, the trolley track and the sheave head track comprise rails that are part of a shared U-shaped profile element. Thus, two rail bodies are provided, each rail body having two flanges that define the guide tracks, or rails, that support the trolley and sheave head.

Thus, each single rail body provides part of the trolley track and part of the sheave head track. The rail body supports both the sheave head and the trolley. The trolley tack and a track for supporting the sheave head are located on opposite sides of said rail, such that the rail is at one side engaged by wheels mounted on the sheave head and on an opposite sides engaged by wheels mounted on the trolley.

In an alternative embodiment, the sheave head is supported on the trolley track, and the trolley is supported on the same track but is located above or below the sheave head.

Thus, a single rail can be used to provide support for both the sheave head and the trolley, which furthermore helps in aligning the sheave head with the trolley, i.e. keeping the sheave head and the trolley at a constant relative position while they move along the heave compensation trajectory.

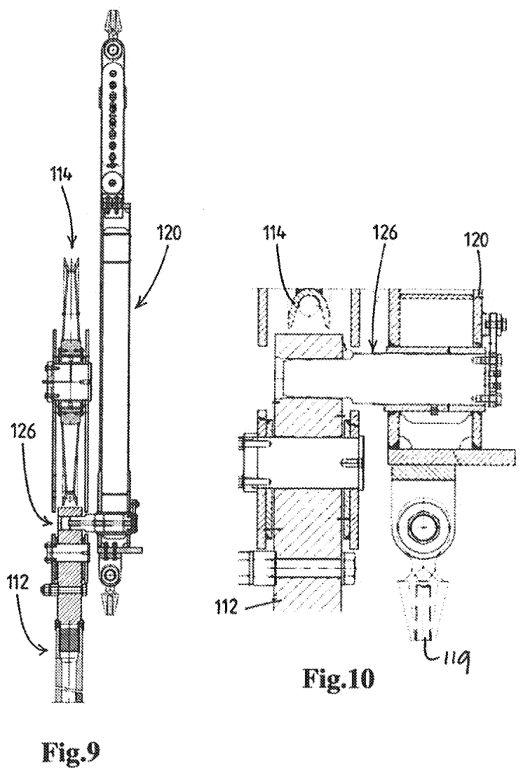

In the preferred embodiment shown, the sheave head track and the trolley track, more in particular the rails of the sheave head track and the rails of the trolley track respectively, define a plane, which planes extend parallel to each other. The trolley 120 is located adjacent the sheave head 110, and is connected with the sheave head via connector device 126, which is shown in more detail in FIGS. 9 and 10.

It is furthermore noted that in the preferred embodiment shown, the section of the adjusting wire 119 that extends along the heave compensation trajectory for pulling the trolley 20 along said trajectory, is located within a plane defined by the trolley track. Thus, the adjusting wire 119 pulling on the trolley 120 does not introduce a pivoting moment on said trolley.

FIG. 9 shows a schematic view in cross section of the trolley 120 and sheave head 110 of FIG. 3, and FIG. 10 shows in close up a section of the connector device 126 connecting the trolley 120 and the sheave head 110 of FIG. 3.

In the preferred embodiment shown, the connector device 126 is embodied as a pin, which pin is received in a receiving opening provided in the sheave head. The pin has a central axis, which central axis crosses the work line, i.e. the central axis, of the heave compensation cylinder. Furthermore, the connector pin 126 has a connector end that is received in an opening in the heave compensation cylinder, in the embodiment shown in the sheave head, which opening is located on the work line, i.e. the opening has a central axis the crosses the work line of the cylinder, of the heave compensation cylinder. Thus, pulling and pushing of the cylinder by the trolley does not introduce bending forces in the piston of the cylinder.

Furthermore, in the embodiment shown, the pin 126 and the opening are shaped such that the connector pin 126 can pivot and/or slide in the opening, such that connection allows for a pivotable movement of the trolley relative to the cylinder head. By allowing the trolley 120, more in particular the connector device 126 mounted on the trolley, to pivot relative to the opening in which it is received, torque is not transferred by the connection. By allowing the connector device to slide in the opening, the connection can adapt to movement of the trolley relative to the work line of the cylinder, for example due to the trolley track extending at a slight angle relative to the central axis of the cylinder, and thus to the heave compensation trajectory.

The opening in which the connector pin 126 is mounted has a convex side wall, the apex of which is located at the central axis of the cylinder. Also, the pin has a curved end section. Thus the pin can pivot while being received in said opening. The connection furthermore allows for the pin to slide in the axial direction of the opening. The opening allows thus for pivot movement as well as a translational movement of the trolley relative to the work line for the cylinder.

In an alternative embodiment, the receiving opening can be part of the top end of the piston of the hydraulic cylinder, or be provided in a component connecting the piston and the sheave head.

In the preferred embodiment shown, the trolley is connected to the rails of the trolley track at spaced locations, in the particular embodiment shown two locations, one on each side of the connector device, such that the track can support a moment acting on the trolley about a moment axis extending perpendicular to the work axis of the cylinder.

Furthermore, in the preferred embodiment shown, the trolley 120 is supported by two rails, and is connected to said rails at four locations, two spaced locations per rail, which locations correspond with four corners of the trolley, more in particular with four corners of the trolley frame.

Furthermore, in the preferred embodiment shown, the trolley track 121 comprises two parallel rails, such that the track can support a moment acting on the trolley about a moment axis extending parallel to the work axis of the cylinder.

In the preferred embodiment shown, the trolley frame is H-shaped, which allows for a comparatively light weight frame and for connecting the frame at for locations to the trolley track.

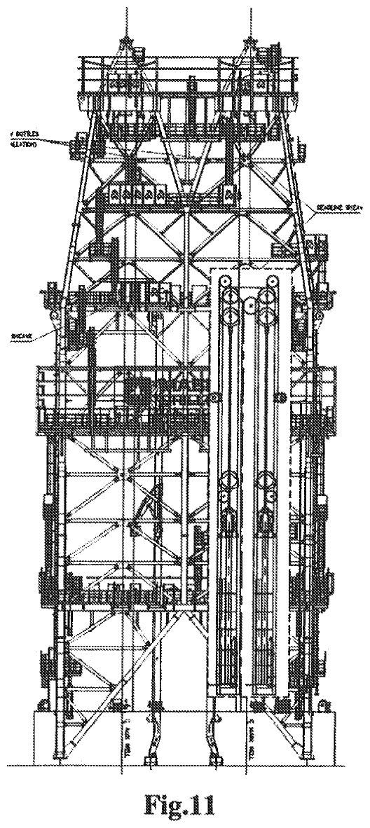

FIG. 11 shows a schematic of a third exemplary embodiment of a heave motion compensation system according to the invention, similar to the adjusting heave motion compensation system, shown in FIGS. 3-10, in which the adjusting heave motion compensation system is provided on the outside of a derrick. In FIG. 11, the cylinders are depicted in both their retracted and their extended position. The embodiment shown differs from the one shown in FIGS. 3-10 in that the adjusting winches are locate halfway the heave compensation trajectory.

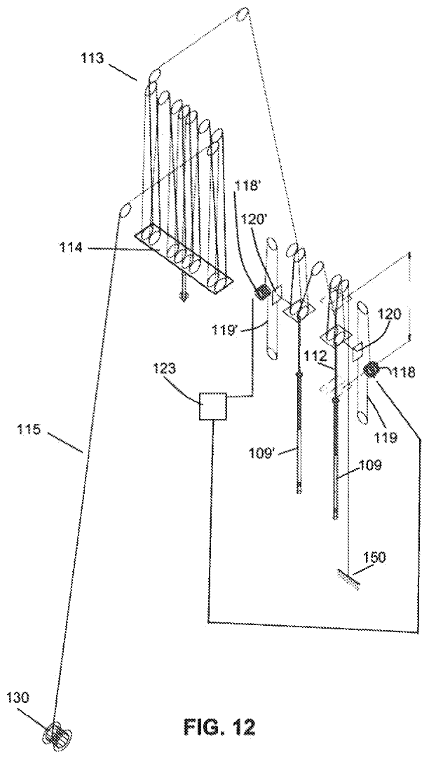

FIG. 12 shows a reeving diagram of a hoisting device and a heave motion compensation system according to the invention. Herein components discussed above have been provided with the same reference numerals.

The hoisting device comprises a hoisting wire 115 that extends from a hoisting winch 130, e.g. the main drawworks winch of a floating drilling vessel, to a crown sheaves set 113 (e.g. at the top of a derrick or a mast) and then to a travelling block 114 having multiple sheaves to achieve a multiple-fall arrangement of the wire 115. For example the travelling block 114 supports or is integrated with a load bearing trolley, e.g. supporting a top drive device adapted to impart torque to a drill string. Here, as preferred, the wire 115 continues to a dead end 150, which may include a further winch at said dead end if desired.

In the path of the wire 115 between the crown sheaves set 113 and the dead end 150 an embodiment of the heave motion compensation system is schematically shown.

Two heave compensation cylinders 109, 109′ each are arranged vertically and each have a piston 112, 112′. For example the stroke length of each piston 112, 112′ is about 15 meters. As is common, each heave compensation cylinder is to be connected to a gas, e.g. nitrogen, buffer, e.g. via a medium separator as known in the art.

Here each piston 112, 112′ carries a sheave head with two sheaves each. The hoisting wire 115 is reeved over both the sheave heads, so is heave compensated by both the cylinders 109, 109′.

As explained herein, for each sheave head there is a non-depicted sheave head track along which the sheave head is guided. Furthermore, for each sheave head there is an associated arrangement of an adjusting winch 118, 118′, adjusting wire 119, 119′, and trolley 120, 120′ and trolley track (not shown for clarity), as well as sheaves for the adjusting wires 119, 119′.

A control device 123 is connected to both adjusting winches 118, 118′ to control the operation thereof as described herein. For example the winches 118, 118 are operator to adjust the heave compensation during a drilling operation wherein a drill string is suspended from the wire 115, via the travelling block 114. This for example allows for enhanced control of the weight-on-bit during drilling.

It will be appreciated that in some situations the reeving of the wire 115 over the sheave heads may be altered, e.g. passing over just one sheave per head, e.g. in view of alterations of the reeving of the wire between the crown sheave set 113 and the travelling block 114.

1. A heave motion compensation system for use with an offshore hoisting device, the heave motion compensation system comprising:
a heave compensation cylinder, said heave compensation cylinder having a piston, the heave compensation cylinder being configured to be connected to a gas buffer for providing an offshore hoisting device with passive heave compensation;
a sheave head comprising one or more sheaves for engaging a hoisting wire of the offshore hoisting device, wherein the sheave head is supported by the piston for movement along a heave compensation trajectory; and
a sheave head track extending parallel to the heave compensation trajectory,
wherein the heave motion compensation system is provided with a heave compensation adjusting system, the heave compensation adjusting system comprising:
an adjusting winch with an associated adjusting wire;
a trolley, the trolley being coupled to the piston of the heave compensation cylinder via a connector device and being coupled to the adjusting winch via the adjusting wire;
a trolley track, the trolley track extending parallel and adjacent to the heave compensation trajectory;
one or more sheaves, located at an end of the adjusting track, for guiding the adjusting wire in a loop along the trolley track, wherein the adjusting winch is configured to pull the trolley, and thus the piston of the heave compensation cylinder, in opposite directions along the heave compensation trajectory; and
a control device, the control device being adapted to control the speed of the adjusting winch.

2. The heave motion compensation system according to claim 1, wherein the sheave head track and the trolley track each define a plane, the planes extending parallel to each other.

3. The heave motion compensation system according to claim 1, wherein the connector device is configured as a pin, the pin having a central axis, the central axis crossing a work line of the heave compensation cylinder, and wherein the connector pin has a connector end that is received in an opening in the heave compensation cylinder, the opening being located on the work line of the heave compensation cylinder.

4. The heave motion compensation system according to claim 3, wherein the pin and the opening are shaped such that the connector pin can pivot in the opening, such that the connection allows for a pivotable movement of the trolley relative to the cylinder head.

5. The heave motion compensation system according to claim 1, wherein the trolley is connected to the trolley track above and below the connector device such that the track absorbs a moment about a moment axis extending perpendicular to a work axis of the heave compensation cylinder.

6. The heave motion compensation system according to claim 1, wherein the trolley track is located above the heave compensation cylinder, alongside the piston of the heave compensation cylinder when said piston is in the extended position.

7. The heave motion compensation system according to claim 1, wherein the adjusting winch is mounted at a far end of the trolley track, located above the sheave head when the heave compensation cylinder is in extended position.

8. The heave motion compensation system according to claim 1, wherein a drum of the adjusting winch is connected with an associated winch drive via a clutch, the clutch being configured to provide a free run condition in which the winch drive and the drum of the winch are disconnected such that the trolley can be pulled along the heave compensation trajectory by the heave compensation cylinder.

9. The heave motion compensation system according to claim 1, wherein the heave compensation system comprises two or more heave compensation cylinders, the heave compensation cylinders each being configured to be connected to a gas buffer for providing the hoisting device with passive heave compensation, and wherein at least one of said two or more heave compensation cylinders is provided with a heave compensation adjusting system.

10. The heave motion compensation system according to claim 1, wherein the heave compensation cylinder provides about 80% of the heave compensation and wherein the heave compensation adjusting system provides about 20% of the heave compensation.

11. The heave motion compensation system according to claim 1, wherein the control device is configured to control the adjusting winch based on drilling information during a drilling process.

12. (canceled)

13. The heave motion compensation system according to claim 1, wherein the heave compensation system comprises a control device that is adapted to control a speed of a hoisting winch of the offshore hoisting device to provide active heave compensation by adjusting the speed of the hoisting winch.

14. (canceled)

15. The heave motion compensation system according to claim 1, wherein the heave motion compensation system further comprises:
a second heave compensation cylinder, said second heave compensation cylinder having a piston, the second cylinder being configured to be connected to a gas buffer for providing the hoisting device with passive heave compensation;
a second sheave head comprising one or more sheaves for engaging a hoisting wire of the hoisting device, wherein the second sheave head is supported by the second piston for movement along a second heave compensation trajectory; and
a second sheave head track, track extending parallel to the second heave compensation trajectory,
wherein the heave compensation adjusting system further comprises:
a second adjusting winch with an associated second adjusting wire;
a second trolley, the second trolley being coupled to the piston of the second heave compensation cylinder via a second connector device and being coupled to the second adjusting winch via the adjusting wire associated with the second adjusting winch;
a second trolley track, the second trolley track extending parallel and adjacent to the second heave compensation trajectory;
one or more sheaves, located at an end of the second adjusting track, for guiding the second adjusting wire in a loop along the second trolley track, wherein the second adjusting winch is configured to pull the second trolley, and thus the piston of the second heave compensation cylinder, in opposite directions along the second heave compensation trajectory; and
a control device, the control device being adapted to control a speed of the second adjusting winch.

16. The heave motion compensation system according to claim 1, wherein the control device is adapted to switch at least one heave compensation cylinder between:
a heave compensation mode, in which the piston of the respective heave compensation cylinder is positioned in an intermediate position to provide a passive or an adjusted heave compensation; and
an overload protection mode, in which the piston of the respective heave compensation cylinder is in a retracted position; and
an underload protection mode, in which the piston of the respective heave compensation cylinder in an extended position.

17. In combination, the heave motion compensation system according to claim 1, and an offshore hoisting device.

18. A floating vessel comprising a hoisting device and the heave motion compensation system according to claim 1, the hoisting device comprising:
a load bearing structure;
a hoisting winch;
a hoisting wire associated with the hoisting winch; and
a connecting mechanism for releasable connecting an object to the hoisting wire.

19. A method for performing a drilling process from a floating vessel comprising a hoisting device and the heave motion compensation system according to claim 1, wherein the method comprises:
supporting the drill string from the floating vessel using the hoisting device;
during the drilling process, providing the hoisting device supporting the drill string with passive heave compensation using the heave compensation cylinder;
controlling the movement of the heave compensation cylinder by using the adjusting winch; and
collecting drilling information and using the drilling information to automatically control the adjusting winch, and thus automatically control the movement of the heave compensation cylinder.

20. The heave motion compensation system according to claim 2, wherein the connector device is configured as a pin, the pin having a central axis, the central axis crossing a work line of the heave compensation cylinder, and wherein the connector pin has a connector end that is received in an opening in the heave compensation cylinder, the opening being located on the work line of the heave compensation cylinder.

21. A method for performing a drilling process from a floating vessel comprising a hoisting device and the heave motion compensation system according to claim 2, wherein the method comprises:
supporting the drill string from the floating vessel using the hoisting device;
during the drilling process, providing the hoisting device supporting the drill string with passive heave compensation using the heave compensation cylinder;
controlling the movement of the heave compensation cylinder by using the adjusting winch; and
collecting drilling information and using the drilling information to automatically control the adjusting winch, and thus automatically control the movement of the heave compensation cylinder.

22. A method for performing a drilling process from a floating vessel comprising a hoisting device and the heave motion compensation system according to claim 3, wherein the method comprises:
supporting the drill string from the floating vessel using the hoisting device;
during the drilling process, providing the hoisting device supporting the drill string with passive heave compensation using the heave compensation cylinder;
controlling the movement of the heave compensation cylinder by using the adjusting winch; and
collecting drilling information and using the drilling information to automatically control the adjusting winch, and thus automatically control the movement of the heave compensation cylinder.
